(19) United States
(12) Patent Application Publication
(10) Pub. No.: US 2009/0322706 A1
(43) Pub. Date: Dec. 31, 2009

(54) INFORMATION DISPLAY WITH OPTICAL DATA CAPTURE

(75) Inventor: Timothy B. Austin, Stony Brook, NY (US)

Correspondence Address: MOTOROLA, INC., 1303 EAST ALGONQUIN ROAD, IL01/3RD, SCHAUMBURG, IL, 60196, US

(73) Assignee: SYMBOL TECHNOLOGIES, INC., Holtsville, NY (US)

(21) Appl. No.: 12/147,108

(22) Filed: Jun. 26, 2008

(51) Int. Cl. G06F 3/042

(52) U.S. Cl. 345/175

(57) ABSTRACT

Systems, devices, and/or methods that facilitate information display with optical data capture are presented. A display surface comprises optically selectable materials and/or contact transparent materials. The disclosed subject matter facilitates displaying information on a surface and collecting optical information about objects interacting with the display surface. The collected optical data, at least in part, is used in determinations related to updating display information. Additional sensors can be incorporated into the system to provide additional information that can be employed in determinations relating to updating display information.

### TECHNICAL FIELD

The subject innovation relates generally to information display devices, methods, and/or systems and more particularly to information display devices, methods, and/or systems having optical data capture capabilities to facilitate user interactions with the information display device, method, and/or system.

### BACKGROUND

Traditionally, information display devices, systems, and methods are single mode in that they are used to display information to a user without interactive capabilities. For example, a CRT screen in an information kiosk can typically display information but interaction with the displayed information will generally be through other modalities than interactions with the CRT display surface, e.g. a user will operate a keyboard or mouse to interact with the displayed information on the CRT display screen. Similarly, for example, a grocery checkout system can have laser bar code scanners, key pads, and debit machine interfaces to interact with information displayed on a checkout display system.

In more modern conventional systems new technologies are enabling direct interaction with the display device to improve the user experience and improve efficiency in, for example, user speed, ergonomics, information communication rates, and footprint and/or cost of devices. One such enabling technology is touch-sensitive layers that can be incorporated into a display device surface. For example, a touch sensitive smart-phone screen can allow users to enter information into a virtual keyboard or keypad, select appointments in a displayed calendar by touching the display surface relative to the appointment, and the like. Also for example, a touch sensitive screen can now frequently be found at grocery supermarket self-checkout counters (and also assisted checkout counters). This can, for example, allow users to select the type of fruit on the weighing surface, enter coupon numbers, select payment type, and request assistance among numerous other functions.

Interactive display technologies can include conductive layer technologies, capacitive sensor technologies, laser-grid technologies, thermal technologies, and video technologies among others. These technologies can generally be divided in to physical contact technologies and purely optical technologies, e.g. a sensor must either “feel” or “see” a user interaction with the display device in typical modern interactive display systems. Generally this feeling and seeing is done from a single side of the display device surface. For example, a touch sensitive layer on a display is typically on the user-side of the display surface (as compared to being behind the display surface). Similarly, most laser-grid systems will also be interposed between the display surface and the user. In contrast, a capacitive sensor system can be located, for example, behind the display surface and interact with the user's finger through the display surface itself.

Typically, optical sensing systems for interactive displays are located on the user side of the display surface. For example, a video camera can monitor interactions of a user's finger with a display surface and through complex computations can interpret movement of the finger in relation to the displayed information on the display surface. Taken to an extreme level, this type of optical technology can result in systems such as the “Kick As Kung-Fu” system from Animaatiokone Industries demonstrated at WIRED NextFest 2006 (see http://www.kickasskungfu.net/en/) or the STEPscape system by Reactrix (see http://www.reactrix.com/site/stepscape_in_action.php). Further, some advanced touch systems, for example, Frustrated Total Internal Reflection (FTIR) systems (see http://cs.nyu.edu/˜jhan/ftirsense/) can employ novel technologies such as wave-guide display surfaces to interact with a user using optical systems located behind the display surface.

Generally, interactive display systems are comparatively expensive and are relegated to special purpose systems. For example, the STEPscape system, supra, is rented to advertising customers and thus distributes the cost of the system among numerous vendors employing the system to interact with public users. Other advanced systems are clearly future concept systems displayed at tradeshows but are not yet commercially unavailable. Moreover, many of these systems lack more than a cursory optical interaction, for example, the FTIR system senses only contact with the display surface. While this is clearly useful for tracking a user's finger as it is dragged across a display (as demonstrated in the video at the URL listed supra), this system would not be able to, for example, read a barcode, photo identification, product tag, color, texture, fingerprint, temperature, ripeness, damage, or other optical information from objects being passed over the display surface.

The use of a display surface enabling optical data capture can facilitate numerous advantageous modalities over current state of the art interactive display technologies. By better modulating the optical characteristics of a display surface, more optical information can be obtained to facilitate these advanced modalities. It is desirable to create devices, systems and methods for facilitating an information display with optical data capture.

### SUMMARY

The following presents a simplified summary of the subject innovation in order to provide a basic understanding of some aspects described herein. This summary is not an extensive overview of the disclosed subject matter. It is intended to neither identify key or critical elements of the disclosed subject matter nor delineate the scope of the subject innovation. Its sole purpose is to present some concepts of the disclosed subject matter in a simplified form as a prelude to the more detailed description that is presented later.

Conventionally, information display devices, systems, and methods are single mode in that they are used to display information to a user without interactive capabilities. For information displays with interactive modalities, these modalities are generally limited to very basic functionalities such as simply tracking an object interacting with the display. This basic interaction is frequently driven by basic touch sensitive displays that “feel” an interaction or by basic optical systems that “see” an interaction. These systems are typically cannot gather more complex optical information, such as for example, fingerprints, color, thermal signatures, UV signatures, bar codes, or the like face down on a display surface that also presents displayed information.

In accordance with one aspect of the disclosed subject matter, an information display with optical data capture is presented. This information display can comprise a display surface component that both facilitates presenting information to a user and also facilitates capture of optical data for objects placed on or near the display surface. The information display with optical data capture can further comprise an optical data capture component to facilitate capturing optical data from objects on or near the display surface and/or a display controller component that can contribute to the control of the information being presented on the display surface.

In accordance with another aspect of the disclosed subject matter, the display surface can comprise a material that has selectable optical properties. As a non-limiting example, the display surface materials can include “smart glass” (also known as “switchable glass” or “e-glass”) which can be switched between a more transparent/translucent state to a less transparent/translucent state by altering an electric field. The display surface can be entirely made of one material such as smart glass, or can include only portions that are optically selectable (e.g., a larger display surface can include smaller “windows” that are optically selectable).

It is important to acknowledge that the terms transparent and translucent can generally be interchanged within this specification. What is generally meant by transparent or translucent is that optical data can be collected through a transparent or translucent material. Conversely, optical data would generally not be captured through non-transparent or non-translucent materials or states. This non-transparent or non-translucent state can be referred to as opaque even where a material is not strictly fully opaque. For example, a dusty window can be called transparent even though some diffusion of light occurs to light traversing the dusty window. Similarly, a faintly milky plastic (e.g. like a milk jug container) can be called transparent even though hyper-technically it is merely translucent. Moreover, a LCD displaying a “white” screen could be called opaque although technically it is transmitting light (e.g., light from the backlight is passing through the LCD making it appear “white”) and thus more accurately would be merely translucent. Thus the use of translucent or transparent generally refers to the more likely probability that optical data could be captured through the transparent or translucent material and the term opaque generally refers to the less likely probability that optical data could be captured through the opaque material. Where it is of particular important that a material is truly transparent, translucent, or opaque, additional language to that effect will be present to communicate the more precise use of the terms and their more specific meaning in the local context.

As a more detailed non-limiting example, a display that is formed of smart glass can be in an “opaque” state onto which a display can be projected. Instructions to a user can be presented on the display surface to request that the customer place produce on the display surface to be weighed. When a sensor indicates that an object has been placed on the display, the smart glass can be “switched” to a transparent mode to allow an image capture device to capture an image of the object placed on the display surface through the transparent display surface. The smart glass can then return to the opaque state. The transition from opaque to transparent and back to opaque can be fast enough that the user barely notices or does not even notice that the display surface transitioned (e.g. somewhere faster than 1/24^{th} of a second), and thus the user can be unaware of any change of state in the display. The captured image of the object, for example a banana, can be analyzed and updated information can be displayed. For example, where the image of the banana is analyzed, it can be determined that the image is of bananas, the bananas are over-ripe, the bananas are organically grown (e.g. an “organically grown indicator” can be on the bananas such as a sticker, a bar code in visible or UV-ink, . . . ), and that the bananas are extra-large bananas. Based on this analysis and the weight of the object on the display surface (e.g., by way of a load cell), the display can be updated with the weight information, the price per pound information, information about the type of banana and that it is organically grown can be presented on the display, and the customer can be informed that a discount is being applied to a sale of the bananas because they are in an over-ripe condition.

In accordance with another aspect of the subject innovation, the display surface can comprise a material that exhibits near-field or contact translucency or transparency. The display surface may be entirely or partially comprised of a contact transparent material similar to the description of an optically selective material display surface as described herein. Near-field and contact transparency or translucency is generally referred to as contract transparency and relates to a condition in which light can be focused through a material only when an object is near to the materials surface or in contact with the surface of the material and that as an object is further removed from the surface of a material light reflected from the object becomes overly diffused and cannot be focused into a coherent image in a particular spectral range. For example, a printed newspaper can be read through cloudy piece of polycarbonate plastic when the paper is in contact with the surface of the plastic, however, as the plastic is raised above the paper, the text quickly becomes unreadable through the hazy polycarbonate. This is discussed in more detail in the detailed discussion section of the specification.

Numerous materials exhibit contact transparency. Contact transparency can result from surface patterning or distress, inks, dyes, laminar structures, lensing, or molecular or crystalline structures or arrangements. The disclosed subject matter in an aspect is directed to the use of contact transparent materials in an information display with optical data capture rather than to contact transparent materials themselves. Thus one of skill in the art will appreciate that any contact transparent material may be substituted where appropriate for the limited and exemplary materials disclosed herein without departing from the spirit of the disclosure and that all such materials used as described herein are properly within the scope of the disclosure.

Reusing the prior example, a display surface can be comprised of a contact transparent material and can display a request for a customer to place produce on the display surface to be weighed. When an object is detected on the display surface, an image can be captured of the limited depth of field in focus through the contact transparent material. For example where a bunch of grapes are placed on the display surface, and the particular contract transparent material allows capture of a 1 mm depth of field, it can be determined from analysis of the captured image that the object is a plurality of grape sized spheres that are reddish in color. This information can then be used to determine a probability that the object is a bunch of red grapes. The display can be updated to reflect the weight (e.g., again by load cell) and type of grapes on the display and the price of the item.

In another aspect, contact transparent materials can improve optical data capture by functioning as a masking element to improve image processing. For example, where a pack of gum is placed on a contact transparent material display surface, an image through the contact transparent surface will be generally uniform (e.g., diffused light where there is nothing near or in contact with the display surface) except for the portion of the gum package in contact with, or near, the display surface. This can simplify data capture by rapidly discarding the uniform field area and focusing analysis of the image on the portion of the display surface in which the gum package is contacting. Thus, rather than image processing, for example, an 8×8 inch image, a much smaller image, for example, 0.5×1.25 inch image can be analyzed. This can significantly improve image processing time for optical data capture systems.

In accordance with another aspect of the subject innovation, the optical data capture component can comprise an imaging device. As a non-limiting example, the optical data capture component can be a visual spectrum imager such as a video or still image camera. This optical data capture component can be located such that imaging is done through the display surface (e.g., the display surface is disposed between the optical data capture device and an object being imaged). Further, the disclosed subject matter includes other or additional forms of optical data capture including other spectral regions of interest, for example, IR, UV, or narrow bands within the visual spectrum. Similarly, optical data capture can include imaging from one or more perspectives (sequentially, simultaneously, or any combination thereof). For example, imaging from both the left and right sides, imaging continuously as the imager pans from left to right or rotates around an object on the display, capturing one or more images from one or more angles of the object interacting with the display surface in a predetermine and/or artificially intelligent manner to obtain more optimal optical information, or combinations thereof, among others. Moreover, other or combination optical data capture modalities can be employed, for example a UV and visual imaging device from the same or different angles among others. Further, alternative illumination of the object can be employed in the optical data capture component to facilitate the selected forms of optical data capture of an object through the display surface component. Further, side imaging can be employed (e.g., using optical components to further capture optical data related to the sides of objects interacting with the display surface).

In accordance with another aspect of the subject innovation, the display controller component can comprise an image forming device. This image forming device can be for example, a digital projector forming an image on the posterior portion of the display surface for viewing by a user on the anterior side of the display surface. The display controller component can also comprise an LCD or other flat panel controller where the display surface comprises an LCD or other flat panel display. One of skill in the art will appreciate that information can be displayed on all or just portions of the display surface.

In accordance with other aspects of the subject innovation, additional sensors can be included to provide additional information about objects interacting with the display surface. These additional sensors can include RFID components, proximity sensors, thermal sensors, load sensors, vibration sensors, capacitive sensors, inductive sensors, voltage or current sensors, radiation sensors, or nearly any other appropriate sensor to facilitate improved sensing of objects interacting with the display surface. These additional sensors can be located in any spatial position and are not limited to sensing through the display surface in the same manner as the primary optical data capture component described herein.

In accordance with an aspect of the disclosed subject matter, a display can be reconfigured to facilitate multiple users. For example, where the display presents a customer with a transaction menu at a bank such that the customer can select, for example, to withdraw $100 as four $20 bills and two rolls of quarters from a savings account and can identify themselves by placing a photo ID on the display surface and placing their pointer finger on the display screen to allow optical data capture of the photo, identity information and fingerprint to identify the correct bank customer. The display image can then be rotated 180 degrees (without needing to physically rotate the display system itself) to present the bank worker with the order, the bank worker can then present their fingerprint to identify which teller completed the transaction (e.g. the tellers fingerprint can be used to populate a bank database related to the transaction). Further, as the teller presents the customer with the funds, the funds can be placed on the display surface to “count” the funds being given to the customer. The display image can then be rotated back to the customer (again without needing to rotate the physical display system) for the customer to use a stylus to “sign” a form indicating that the transaction was completed (e.g., the electronic ink image can be captured and displayed on the display surface and stored in a database for future reference). One of skill in the art will appreciate that numerous other permutations of display reconfiguration (e.g. rotation, inversion, displaying different user interface elements such as signature lines, fingerprint zones, photo ID zones, product zones, object zones, . . . ) can provide improved display flexibility where these reconfigured displays can be combined with optical data capture opportunities.

To the accomplishment of the foregoing and related ends, the innovation, then, comprises the features hereinafter fully described and particularly pointed out in the claims. The following description and the annexed drawings set forth in detail certain illustrative embodiments of the innovation. These embodiments can be indicative, however, of but a few of the various ways in which the principles of the innovation can be employed. Other objects, advantages, and novel features of the innovation will become apparent from the following detailed description of the innovation when considered in conjunction with the drawings.

### BRIEF DESCRIPTION OF THE DRAWINGS

FIG. 1 is a diagram of a system that can facilitate information display with optical data capture in accordance with an aspect of the subject matter disclosed herein.

FIG. 2 is a diagram of a system that can facilitate information display with optical data capture in accordance with an aspect of the subject matter disclosed herein.

FIG. 3 is a diagram of a system that can facilitate information display with optical data capture in accordance with an aspect of the subject matter disclosed herein.

FIG. 4 is a diagram of a system that can facilitate information display with optical data capture in accordance with an aspect of the subject matter disclosed herein.

FIG. 5 is a diagram of a system that can facilitate information display with optical data capture in accordance with an aspect of the subject matter disclosed herein.

FIG. 6 is a diagram of a system that can facilitate information display with optical data capture and additional sensor components in accordance with an aspect of the subject matter disclosed herein.

FIG. 7 is a diagram of exemplary systems that can facilitate information display with optical data capture in accordance with an aspect of the subject matter disclosed herein.

FIG. 8 illustrates a display surface component that facilitates dynamic reconfiguration of displayed information in accordance with an aspect of the disclosed subject matter.

FIG. 9 illustrates a display surface component that facilitates dynamic reconfiguration of displayed information in accordance with an aspect of the disclosed subject matter.

FIG. 10 illustrates a display surface component that facilitates contact transparency optical masking in accordance with an aspect of the disclosed subject matter.

FIG. 11 illustrates photos of an exemplary contact transparency material displaying a more translucent and less translucent state in accordance with an aspect of the disclosed subject matter.

FIG. 12 illustrates a methodology that can facilitate information display with optical data capture in accordance with an aspect of the subject matter disclosed herein.

FIG. 13 illustrates a methodology that can facilitate information display with optical data capture in accordance with an aspect of the subject matter disclosed herein.

FIG. 14 illustrates a methodology that can facilitate information display with optical data capture in accordance with an aspect of the subject matter disclosed herein.

FIG. 15 illustrates a methodology that can facilitate information display with optical data capture with additional sensor component inputs in accordance with an aspect of the subject matter disclosed herein.

FIG. 16 illustrates a block diagram of an exemplary electronic device that can utilize dynamic allocation or inferential dynamic allocation of battery capacity in accordance with an aspect of the disclosed subject matter.

### DETAILED DESCRIPTION

The disclosed subject matter is described with reference to the drawings, wherein like reference numerals are used to refer to like elements throughout. In the following description, for purposes of explanation, numerous specific details are set forth in order to provide a thorough understanding of the subject innovation. It is evident, however, that the disclosed subject matter can be practiced without these specific details. In other instances, well-known structures and devices are shown in block diagram form in order to facilitate describing the subject innovation.

Traditional display surfaces function only to present information to a user. These display surfaces are frequently divorces from the myriad of input devices used for interaction with a system relate do the displayed information. For example, a traditional information kiosk in a mall can have a display and a series of selection buttons below the display. The user would view information presented on the display in response to interactions with the buttons below the display. This type of system can result in a user having to shift focus from the display to the buttons and back again. Further very little additional information can be gleaned from the interaction of the user with the button inputs.

Advances in traditional technologies have allowed improved interaction with display surfaces. These more advanced state of the art display surface systems can use cameras and light sensors to determine limited information related to a user interacting with the display surface. More particularly, camera type systems generally rely on capturing user-display interactions from the user side of the display, e.g., the camera is often looking at the display surface from the same or similar perspective as the user. This can present a rich image for analysis but can also result in obfuscation of the display from the camera system and an excessive amount of information in the image, both requiring excessive amounts of processing to deduce the actions of the user-display interaction. One solution in these systems has been to use coarse granular video or still image information, e.g., degrading the captured information to allow faster processing.

Some display surface technologies allow for data capture from a user-display interaction where the display is interposed between the user and the light sensing system. More particularly, these systems rely on effects, such as interference to a waveguide, to produce causal spectral beacons in response to a user's interaction with a display surface. However, these systems fail to gather optical data related to the object itself which is interacting with the display surface. For example, a FTIR system (see background section herein) can produce a “bright spot” on the sensor side of a display surface (e.g., such that the display surface is disposed between the user and the light sensor). However, this imaging of this bright spot is not imaging of the user's finger itself where it is in contact with the display surface.

In contrast to these current state of the art display surfaces, the disclosed subject matter presents an information display surface with optical data capture of objects interacting with the display. This optical data capture occurs through the display surface meaning that optical information can be captured from the portion of an object facing or touching the display surface itself. This can reduce or eliminate the obfuscation problems associated with video systems having the camera located on the user side of a display. Further unlike the FTIR system, optical data is captured from the interacting object itself and not just data relating to effects caused by the interacting object (e.g., an image of the user's finger can be captured through the display surface as compared to just detecting light caused by the user's finger interfering with a waveguide.)

In one aspect, the information display with optical data capture can comprise a display surface that exhibits contact transparency and/or is optically selectable. As stated in the summary section herein, it is important to acknowledge that the terms transparent and translucent can generally be interchanged within this specification. What is generally meant by transparent or translucent is that optical data can be collected through a transparent or translucent material. Conversely, optical data would generally not be captured through non-transparent or non-translucent materials or states. This non-transparent or non-translucent state can be referred to as opaque even where a material is not strictly fully opaque. Thus the use of translucent or transparent generally refers to the more likely probability that optical data could be captured through the transparent or translucent material and the term opaque generally refers to the less likely probability that optical data could be captured through the opaque material. Where it is of particular important that a material is truly transparent, translucent, or opaque, additional language to that effect will be present to communicate the more precise use of the terms and their more specific meaning in the local context.

A contact transparent display surface is a surface that is generally translucent for objects in contact with the surface or within a predetermined near-field of the surface. As an object's distance from the surface is increased beyond the predetermined near-field distance, the light from the object rapidly becomes increasingly diffused and results in an increasingly unfocused image. Thus, as disclosed in the summary section herein, near-field and contact transparency or translucency is generally referred to simply as contract transparency and relates to a condition in which light can be focused through a material only when an object is near to the material's surface or in contact with the surface of the material. Numerous materials exhibit contact transparency. Contact transparency can result from surface patterning, deformation or distress, inks, dyes, laminar structures, refraction or diffraction gratings, lensing, or molecular or crystalline structures or arrangements. The disclosed subject matter in an aspect is directed to the use of contact transparent materials in an information display with optical data capture rather than to contact transparent materials themselves. Thus one of skill in the art will appreciate that any contact transparent material may be substituted where appropriate for the limited and exemplary materials disclosed herein without departing from the spirit of the disclosure and that all such materials used as described herein are properly within the scope of the disclosure.

An optically selectable material is a material in which the transparency or translucency of the material can be selectively altered. Numerous materials exhibit optical selectability, one well known exemplary material is “smart glass” (also known as “switchable glass” or “e-glass”), which can be switched between a more transparent/translucent state to a less transparent/translucent state by altering an electric field. One of skill in the art will appreciate that any optically selectable material may be substituted where appropriate for the exemplary materials disclosed herein without departing from the spirit of the disclosure and that all such materials used as described herein are properly within the scope of the disclosure.

The use of either material in a display surface can facilitate optical data capture from objects interacting with the display surface wherein the display is disposed between the interacting object and the optical data capture component. Where these types of materials can allow optical data capture of aspects of the interacting objects themselves, numerous advantages over current state of the art systems can be realized. For example, point of sale systems can allow data capture of objects being purchased just by placing the objects on the display (e.g., a self checkout at the grocery store can determine the type of produce being placed on the display surface), banking systems can capture picture ID and fingerprint information directly on the display surface used for the transaction, store kiosks can give pricing information by capturing bar code information on a clothing price tag pressed to the display surface, advertisers can capture additional information from users interacting with an advertisement on a display surface, or nearly a limitless number of other examples that can benefit from imaging an interacting object through the display surface itself.

In another aspect, contact transparent materials can function to optically mask items reducing the computational complexity of optical analysis. This masking can occur because the optical system can be trained to ignore diffused portions of the display surface. Thus, where an object is in the near-field or contact with the display surface, the image of the object through the display surface can occupy less than the whole contact transparent display surface resulting in both diffused portions and image portions. By ignoring the diffused portions, the optical data collection component can analyze just the portion of the display surface in contact (or near-field) of the object which can represent a reduced area for analysis. Generally speaking, the optical data capture component need only look at the portion of the contact transparent display surface in contact with the object and can ignore the rest of the image and thus reduce computational complexity in analyzing the image.

In another aspect, a nearly limitless number of optical data capture permutations exist for capturing optical data through the display surface. These can include but are not limited to, visible/IR/UV spectrum, other spectral regions, narrow band spectral regions, multiple image capture devices, translation and rotation of image capture devices, employing advanced optics to capture the sides of an object (e.g., with selectable optical materials or within the near-field of a contact transparent material), among many other variations on optical data capture from objects interacting with a display surface where the display surface is disposed between the interacting object and the one or more optical data capture components. One of skill in the art will appreciate that all such permutations of optical data capture fall within the scope of the disclosed subject matter where such optical data capture occurs through the display surface as herein described.

In another aspect, a display controller component can affect the displayed information presented on the display surface in response to determinations made at least in part on captured optical data. This can allow, for example, a display to be updated with a price for a captured barcode held to the display, can update a display to reflect a lower price on over-ripe bananas placed on the display for weighing, or can update a display to show a current account balance in response to capturing a customer's fingerprint held to the display, etc. Similarly, the display controller can incorporate non-optical information to affect the display, for example a display can be adjusted from a self-checkout mode to an assisted checkout mode in response to a store associate becoming available to assist in a transaction.

In another aspect, additional sensor information can also be incorporated to augment or supplement optical data capture. These additional sensors can include load cells, RFID tag sensors, proximity sensors, temperature sensors, position sensors, or nearly a limitless number of other sensors that can be spatially located anywhere within the system that is appropriate for the particular sensor. For example, where a display surface is disposed horizontally in a self-checkout system, the display system can include load cells under the display to allow weights of objects placed on the display (e.g., produce) to be calculated and such data incorporated into related determinations (e.g., into the optical analysis, into displayed information, . . . ).

Various combinations of these aspects can result in highly tailored systems, devices or methods that incorporate information display with optical data capture as disclosed herein. As non-limiting exemplary systems to illustrate possible specialized systems benefiting from optical data capture through a display surface, systems can include grocery store point of sale systems, mall information kiosks, banking systems and ATMs, security check points, smartphones and personal digital assistants (PDAs), airplane or other vehicle instrumentation, desktop and portable computer systems, interactive advertisements, videogames, etc.

The subject innovation is hereinafter illustrated with respect to one or more arbitrary architectures for performing the disclosed subject matter. However, it will be appreciated by one of skill in the art that one or more aspects of the subject innovation can be employed in other memory system architectures and is not limited to the examples herein presented.

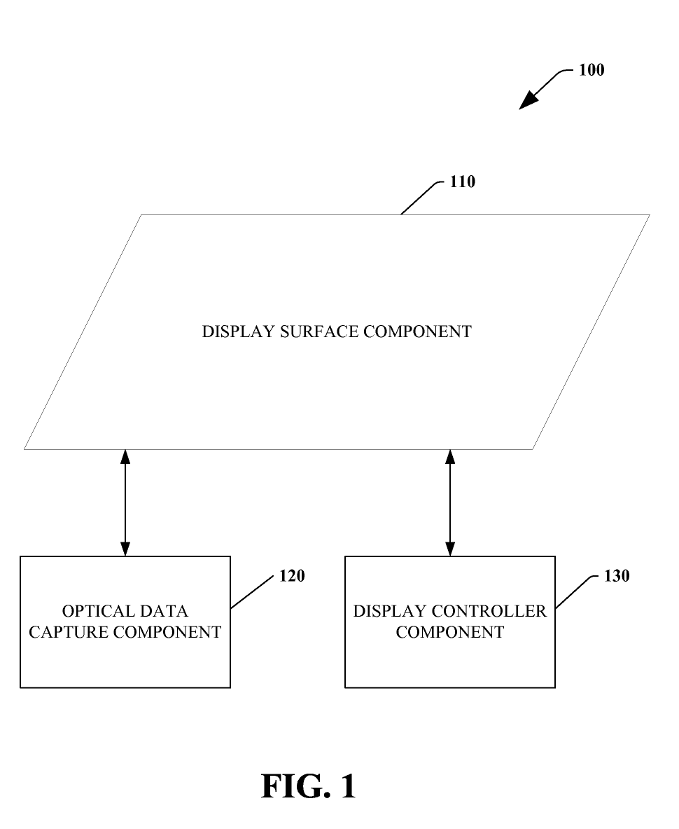

Turning to FIG. 1, illustrated is a diagram of a system 100 that can facilitate information display with optical data capture in accordance with an aspect of the subject matter disclosed herein. System 100, for example, can include a display surface component 110. Display surface component 110 can facilitate optical data capture from objects interacting with the display surface component 110. System 100 can further include one or more optical data capture components 120. Optical data capture component 120 can facilitate capturing optical data related to objects interacting with display surface component 110. System 100 can further include one or more display controller components 130. The display controller components 130 can affect the displayed information presented on the display surface component 110.

In an aspect, display surface component 110 can both display information and facilitate optical data capture through the display surface component 110. For example, optical data capture component 120 can capture optical data of a user's finger pressed against display surface component 110 (e.g., the optical data of the fingerprint is captured through the display surface component 110 by the optical data capture component 120, thus the display surface component 110 is disposed between the finger and the optical data capture component 120). The display controller component 130 can then update the information presented on the display surface component 110 in response to determinations related to the captured fingerprint information.

System 100 is distinctly different than segmented display devices having an optically clear window disposed therein. Display systems that incorporate a built in window generally are unable to display information within the window portion of the display. In contrast, the disclosed subject matter discloses a display surface component 110 that exhibits optical qualities (e.g., the optical properties are selectable or exhibit contact transparency) allowing information to be displayed on the same portion of the display surface component 110 as also can be employed for optical data capture (e.g., by selectably transitioning the transparent state of an optically selectable material or from having an item in the near-field or in contact with a contact transparent display surface) by the optical data capture component 120 through the display surface component 110. Generally, the same surface that displays information can also allow optical data capture transmitted through the display surface.

In another aspect, system 100 can comprise a display surface component 110 having an active display surface that is entirely an optically selectable material or entirely a contract transparent material. In the alternative, portions of the active display surface component 110 can be comprised of an optically selectable materials, contract transparent materials, or combinations thereof. For example, a display surface component 110 can be all smart glass or can have only windows of smart glass. By employing smaller sections of smart glass, the resulting device can, for example, consume less power or be more cost effective to deploy while still allowing information display on, and optical data capture through, the smart glass portions of the display surface component 110.

In another aspect, additional sensor components can be incorporated into system 100. These additional sensors can facilitate determinations related to interactions with the display surface component 110. For example, these additional sensors can include RFID tag readers, thermal sensors, additional imaging sensors, position sensors, load cell sensors, proximity sensors, light sensors, humidity sensors, chemical sensors, electrical sensors (voltage, current, capacitance, inductance, resistance, . . . ), or combinations thereof among numerous other well known sensors. In a particular non-limiting example, a load cell sensor can be incorporated into a grocery store point of sale system 100 to determine the weight of produce placed on a display surface component 110 of the system 100. One of skill in the art will appreciate that all such additional data streams from any sensor that augments the performance of the herein disclosed subject matter is to be similarly considered within the scope of the disclosed subject matter.

In another aspect, the nature of the display surface component 110 of system 100 can facilitate easy reconfiguration of the display. For example, display controller component 130 can facilitate rotating the displayed image of the information displayed on display surface component 110 to between accommodating self-service checkout (e.g., the display is oriented to the customer) and assisted checkout (e.g., the display is oriented to a grocery clerk assisting a customer).

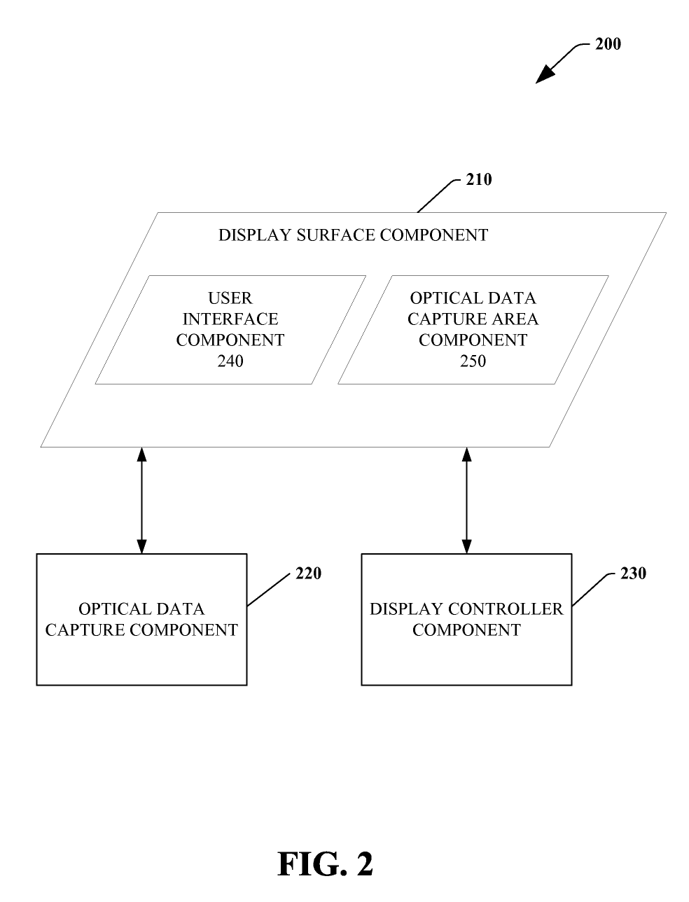

Referring now to FIG. 2, illustrated is a diagram of a system 200 that can facilitate information display with optical data capture in accordance with an aspect of the subject matter disclosed herein. System 200 can be the same as or similar to system 100. System 200 can include a display surface component 210, an optical data capture component 220 and a display controller component 230 that can be the same as or similar to components 110, 120, and 130 respectively. Display surface component 210 can further include a user interface (UI) component 240 and an optical data capture area (ODCA) component 250.

The UI component 240 can facilitate presenting information for display on the display surface component 210 that can be an interface for a user of system 200. UI component 240 can, for example, be an information presentation area only (e.g., a passive user interface that can be functionally similar to a conventional display device such as an LCD panel). The UI component 240 can, also for example, be a touch sensitive display area allowing the user to interact with the displayed information (e.g., the UI can be functionally similar to a conventional touch screen panel, such as a virtual keyboard/keypad). Further, for example, the UI component 240 can be a discrete interface (e.g., the UI 240 can be a series of contact switches that function as soft-buttons in conjunction with the display). Moreover, the UI component 240 can be a user interface area comprising optical data capture in accordance with the herein disclosed subject matter (e.g., the UI can include an area allowing optical data capture through the same area used to display information, for example, a virtual keyboard can be displayed in the UI component 240 and the user touches can be captured optically through the displayed virtual keyboard by optical data capture component 220).

The ODCA component 250 of display surface component 210 can facilitate optical data capture in accordance with the disclosed subject matter. Thus, for example, where user interface functions are relegated to a UI component 240, the ODCA component 250 can serve, for example, as a dedicated optical data capture area. In a more particular non-limiting example, the UI component 240 can include a contact transparent material to facilitate virtual keypad and ODCA component 250 can include an smart glass panel for capturing banking information from paper checks placed within imaged alignment marks in the ODCA component 250 area. This particular example illustrates that various materials can be combined within information display with optical data capture devices and systems. Thus, in the example, where finger touches are easily optically detected in the UI component 240 area, the improved transparency of smart glass in the ODCA component 250 area can facilitate improved optical data capture of the exemplary routing and account information from paper checks placed face down on the display surface component 210.

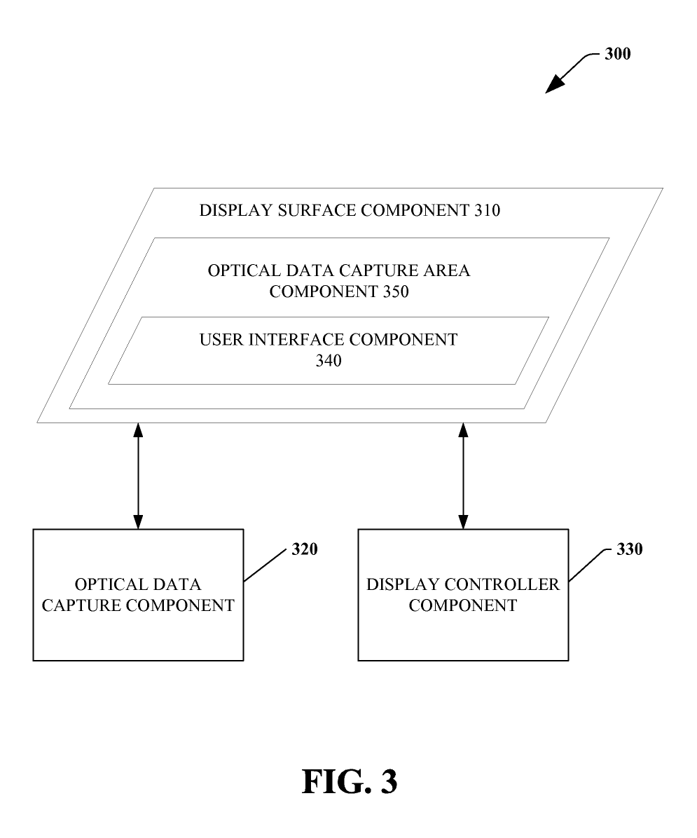

Referring now to FIG. 3, illustrated is a diagram of a system 300 that can facilitate information display with optical data capture in accordance with an aspect of the subject matter disclosed herein. System 300 can be the same as or similar to system 100 or 200. System 300 can include a display surface component 310, and optical data capture component 320 and a display controller component 330 that can be the same as or similar to components 110, 120, and 130 respectively and can also be the same as or similar to components 210, 220, and 230 respectively. Further, display surface component 310 can include a UI component 340 and an ODCA component 350 that can be the same as or similar to component 240 and 250 respectively. In an aspect system 300 illustrates that subcomponent areas of the display surface component 310 can be spatially oriented (e.g., similar to system 200) or can be nested. System 300 illustrates the UI component 340 being nested within the ODCA component 350. One of skill in the art will appreciate that this particular nesting order is arbitrary and that any suitable nesting order can be employed without deviating from the spirit and scope of the disclosed subject matter. Further, one of skill in the art will appreciate that nesting and spatial orientation can be employed to result in a nearly limitless number of display surface configurations and that all such configurations are within the scope of the disclosed subject matter.

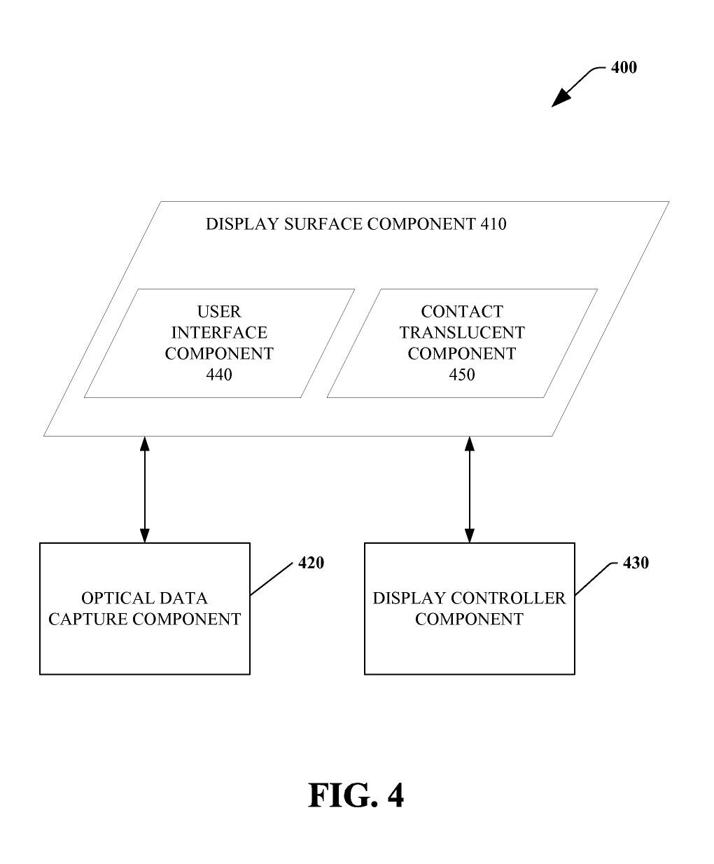

Referring now to FIG. 4, illustrated is a diagram of a system 400 that can facilitate information display with optical data capture in accordance with an aspect of the subject matter disclosed herein. System 400 can be the same as or similar to system 100 or 200. System 400 can comprise a display surface component 410, an optical data capture component 420, a display controller component 430 and a user interface component 440 that can be the same as or similar to components 210, 220, 230, and 240 respectively. System 400 can further comprise a contact translucent component 450. The contact translucent component 450 can comprise a contact translucent material as herein described to facilitate contact translucent behavior in accordance with the disclosed subject matter. One of skill in the art will appreciate that the particular contact translucent material can be selected for the desired optical properties (depth of the near-field, translucency, durability, . . . ) and that all such resulting contact translucent components 450 are within the scope of the disclosed subject matter.

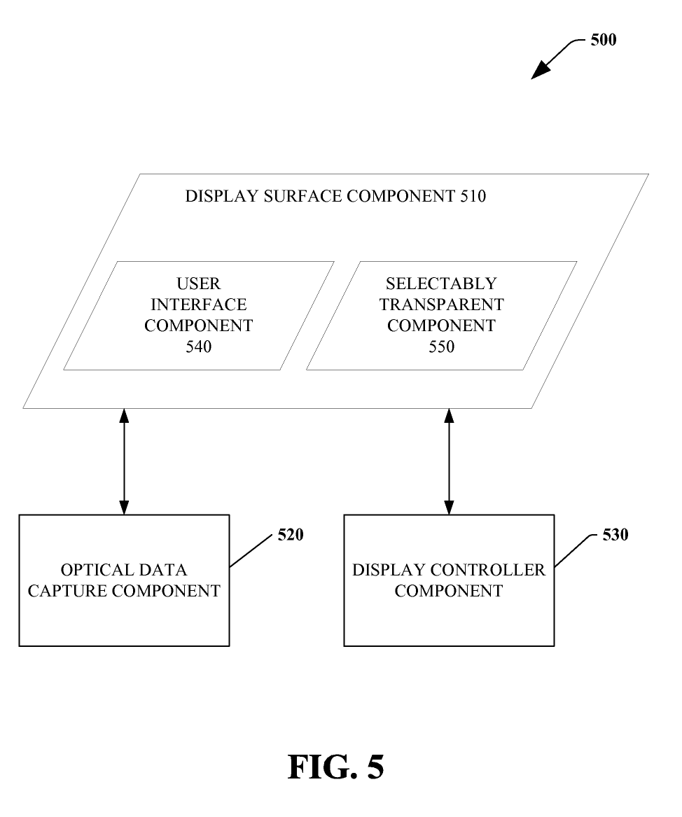

Referring now to FIG. 5, illustrated is a diagram of a system 500 that can facilitate information display with optical data capture in accordance with an aspect of the subject matter disclosed herein. System 500 can be the same as or similar to system 400. System 500 can further comprise a selectably transparent component 550. The selectably transparent component 550 can comprise an optically selectable material as herein described to facilitate selectable transparent behavior in accordance with the disclosed subject matter. One of skill in the art will appreciate that the particular optically selectable material can be selected for the desired optical properties (e.g., translucency, transition time, MTBF, event triggering levels, . . . ) and that all such resulting selectably transparent component 550 are within the scope of the disclosed subject matter.

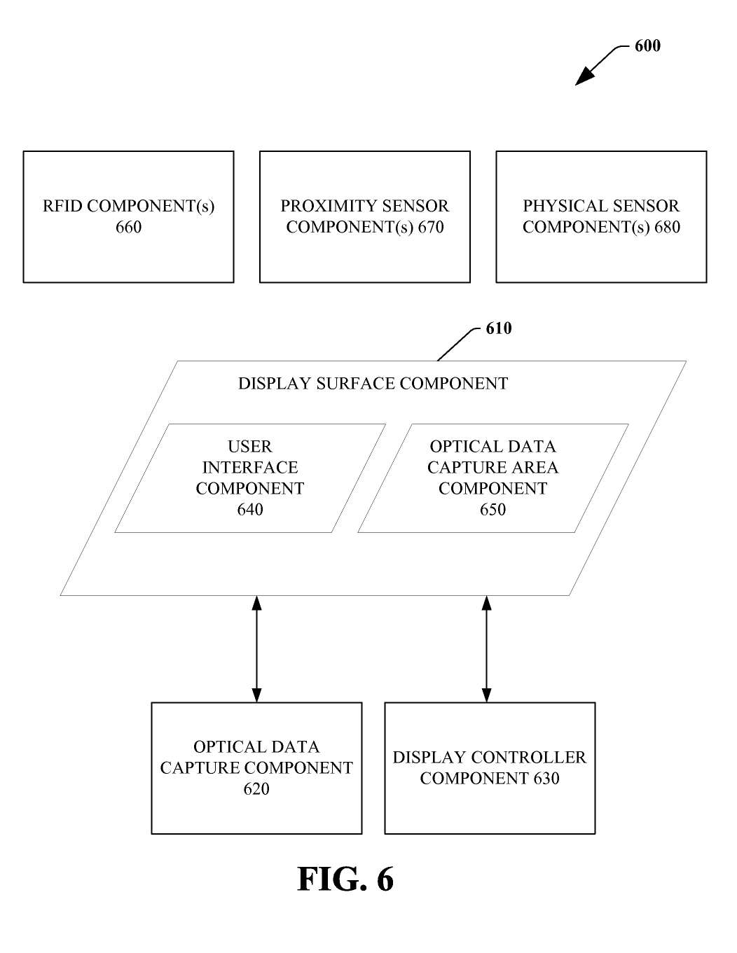

Referring now to FIG. 6, illustrated is a diagram of a system that can facilitate information display with optical data capture and additional sensor components in accordance with an aspect of the subject matter disclosed herein. System 600 can be the same as or similar to systems 100, 200 or 300. System 600 can thus include a display surface component 610, optical data capture component 620, display controller component 620, UI component 640 and an ODCA component 650 similar to or the same as those previously described herein. System 600 can further include one or more of an RFID component 660, a proximity sensor component 670, and a physical sensor component 680.

In an aspect, the RFID component 660 can include an RFID tag reader to read RFID tags on objects interacting with the display surface component 610. For example, where a sweater has an RFID tag and a bar code tag, the bar code tag can be optically captured through the display surface component 610 by the optical data capture component 620. The RFID component 660 can similarly capture the RFID tag information as of the sweater. The RFID information can, for example, indicate that the sweater is $100. The barcode tag can indicate, for example, that the sweater is $300. This conflicting information can cause a determination relating to displaying information, by way of the display controller component 620, informing the user that there is a pricing conflict. This information can, for example be used to cause a further investigation into the correct pricing of the sweater.

In another aspect, the proximity sensor component 670 can function to indicate that objects are within the proximity of the display surface component 610. For example, the system 600 can go into low power mode until an object triggers the proximity sensor 670 which can result in the system 600 coming out of low power mode. The proximity sensor component 670 can also indicate relative position of objects near the display surface component 610, for example, indicating that an object in contact with the display surface component 610 is less than a predetermined distance height to, for example, help distinguish between a 12 oz can and a 16 oz can having the same footprint.

In another aspect, a physical sensor component 680 can include numerous other types of physical sensors such as biofeedback devices (e.g. haptics, retinal scanners, pulse-oxymeters, thermal sensors, . . . ), chemical sensors (e.g., ethylene sensors for determining ripeness of fruit, toxin or explosive sensors such as for airport security display interfaces, . . . ) or other physical sensors appropriate to the particular embodiment.

One of skill in the art will appreciate that numerous additional sensors and sensor systems can be incorporated into devices and systems in accordance with the disclosed subject matter to provide additional functionality or improved performance under various situations and conditions. Further, one of skill in the art will appreciate that the inclusion of these sensors, while too numerous to explicitly disclose, is within the scope of the disclosed subject matter.

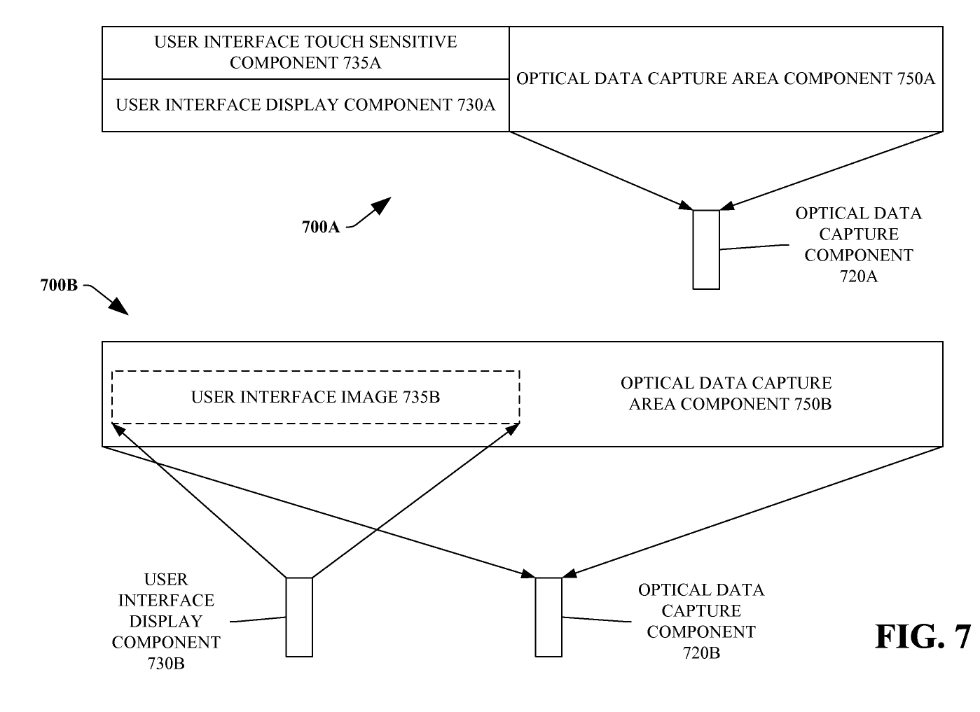

Referring now to FIG. 7, illustrated is a diagram of exemplary systems 700A and 700B that can facilitate information display with optical data capture in accordance with an aspect of the subject matter disclosed herein. System 700A illustrates a display surface that is physically divided into an ODCA component 750A, that can be the same as or similar to other ODCA components described herein, and a UI portion. The UI portion illustrates a non-limiting exemplary laminar structure comprising a UI touch sensitive component 735A which can be, for example, a conductive touch sensing layer, disposed over a UI display component, which can be for example an LCD panel. Thus system 700A represents physical separation of some display and sensing components similar to that discussed herein in regard to possible embodiments of component 240 (see FIG. 2 and corresponding discussion).

System 700B represents an alternative embodiment (again see discussion of component 240 from FIG. 2) wherein the ODCA component 750B is logically separated from a UI 735B (e.g. UI 735B is an imaged interface rather than a physically discrete interface as in system 700A). Further, system 700B illustrates a UI display component 730B that can be the same as or similar to display controller components 130, 230, 330, 430, 530 or 630.

Both system 700A and 700B comprise an optical data capture component, 720A and 720B respectively, that can be the same as or similar to optical data capture component 120, 220, 30, 420, 520 or 620. Thus, FIG. 7 illustrates that, similar to the discussion related to FIG. 2, a nearly limitless number of combinations of conventional display and interface technologies can be combined effectively with information display with optical data capture aspects as herein disclosed. One of skill in the art will appreciate that any combination of the conventional technologies with the patentable aspects of the disclosed subject matter would result in a device, system or method within the protectable scope of the herein disclosed subject matter.

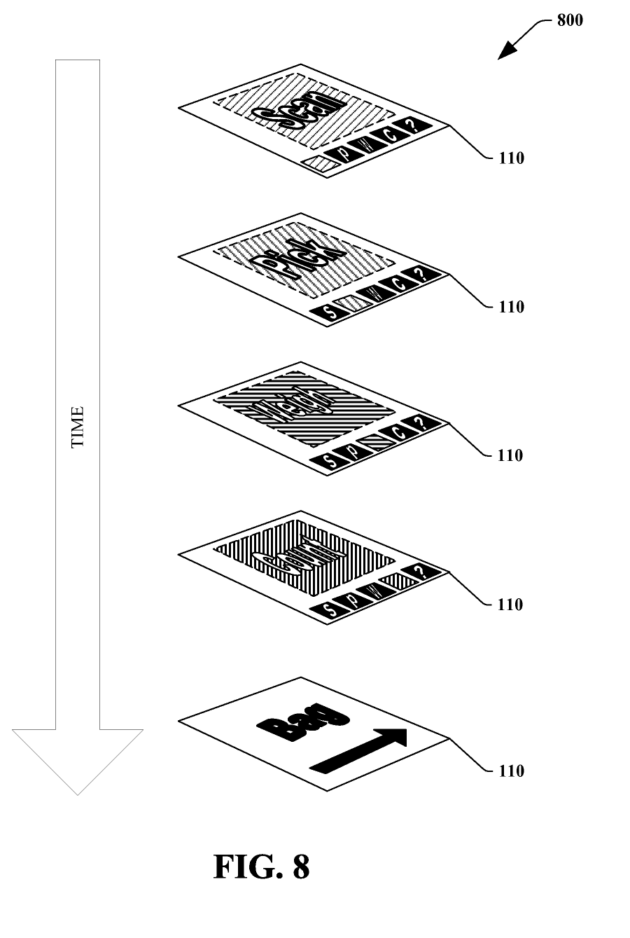

Referring now to FIG. 8, illustrated is a display surface component that facilitates dynamic reconfiguration of displayed information in accordance with an aspect of the disclosed subject matter. The display surface component 110 changing with time is illustrated in the series of images 800. FIG. 8 demonstrates that the display surface component 110 can represent numerous features and functions related to information display and optical data capture. In series 800, “scan”, “pick”, “weigh”, and “count”, represent non-limiting exemplary display areas (they instruct a user to scan, pick, weigh, or count) that can also capture optical data (e.g. objects placed in those areas can, for example, be scanned, picked, weighed, or counted). Further “bag” indicates the display surface 110 functioning as a display only.

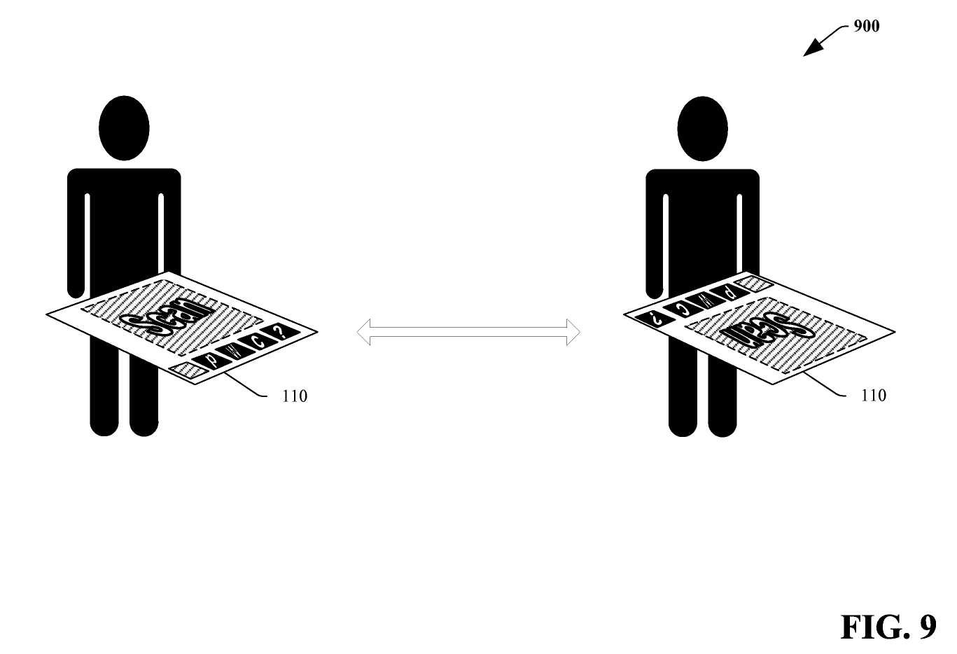

Referring now to FIG. 9, illustrated is a display surface component that facilitates dynamic reconfiguration of displayed information in accordance with an aspect of the disclosed subject matter. As herein discussed, the display surface 110 can be reconfigured. FIG. 9 illustrates a non-limiting exemplary transition 900 between a customer assisted checkout modality and a self-checkout modality. Transition 900 illustrates that the image can be rotated to accommodate various users of the display surface while providing the herein described functional aspects that are an improvement over the current state of the art for displays.

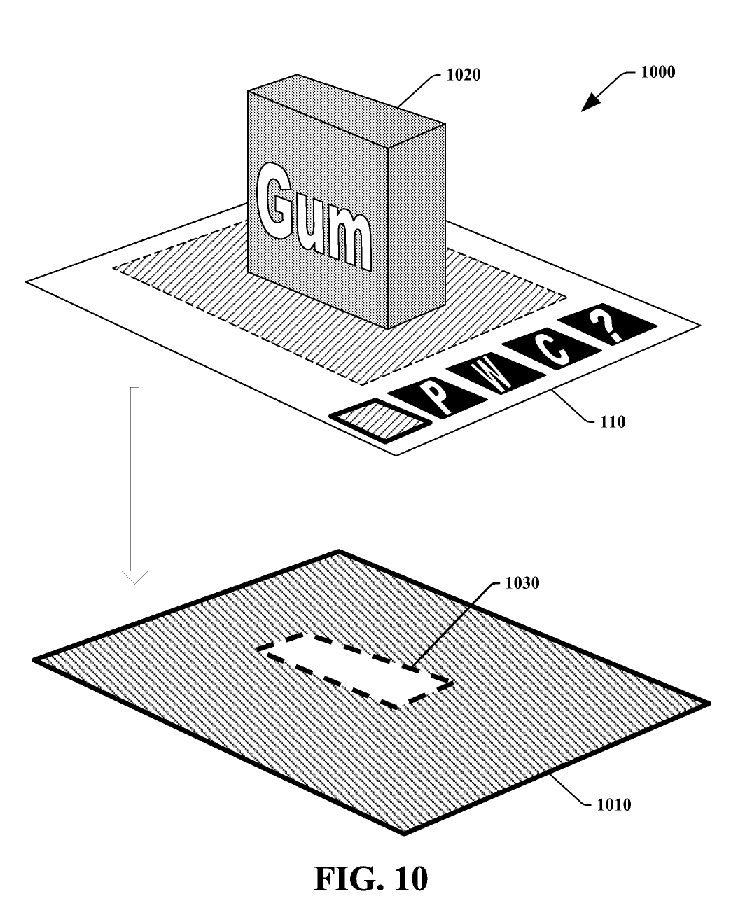

Referring now to FIG. 10, illustrated is a display surface component system 1000 that facilitates contact transparency optical masking in accordance with an aspect of the disclosed subject matter. Contact transparency masking as herein disclosed can facilitate reduced computational complexity by reducing the imaged area to be analyzed. As illustrated, the display surface 110 of system 1000 can have object 1020 placed on the display surface 110. Where this display surface comprises a contact transparency material, only the portion of the display surface 110 in contact with the object 1020 will image in focus. Thus, the in focus portion is illustrated as 1030 in a field of diffused images 1010. Where the optical analysis ignores the diffused field 1010, only the image in 1030 need be optically analyzed. This can effectively reduce optical calculations from all of 1010 (including 1030) in non-masked systems, to just 1030 in masked systems. This masking is inherent in contact transparency materials and this inherent feature of these materials can be used to great advantage in the disclosed subject matter as herein described.

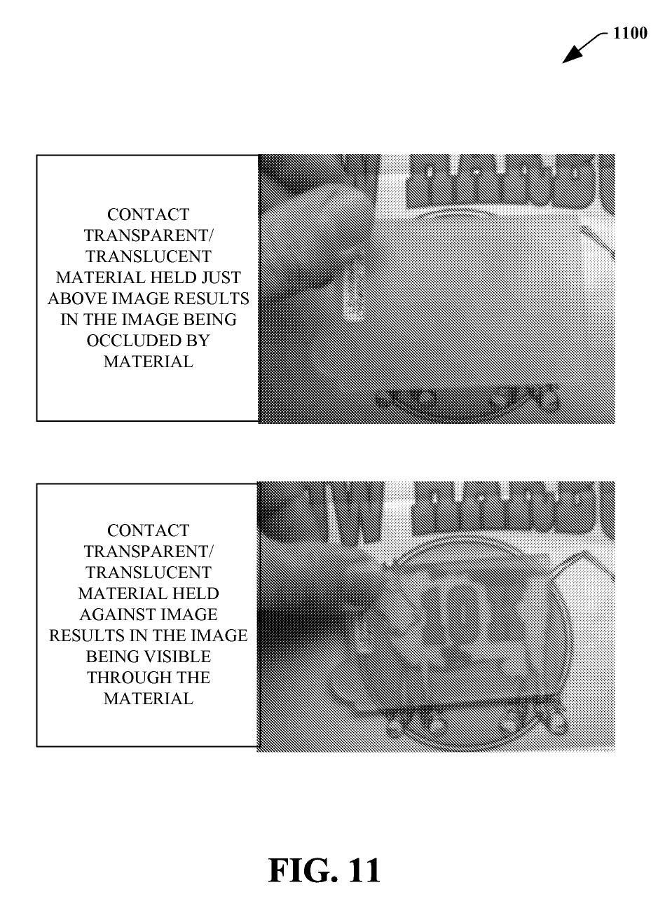

Referring now to FIG. 11, illustrated are photos of an exemplary contact transparency material displaying a more translucent and less translucent state in accordance with an aspect of the disclosed subject matter. In the top image, the contact transparency material is located further than the near-field distance and the object behind the material is completely diffused (e.g. no coherent image can be formed “looking” through the contact transparent material in the top image). In contrast, in the bottom image of FIG. 11, the contact transparency material is held in contact with the object and an image of the object is clearly visible through the contact transparent material.

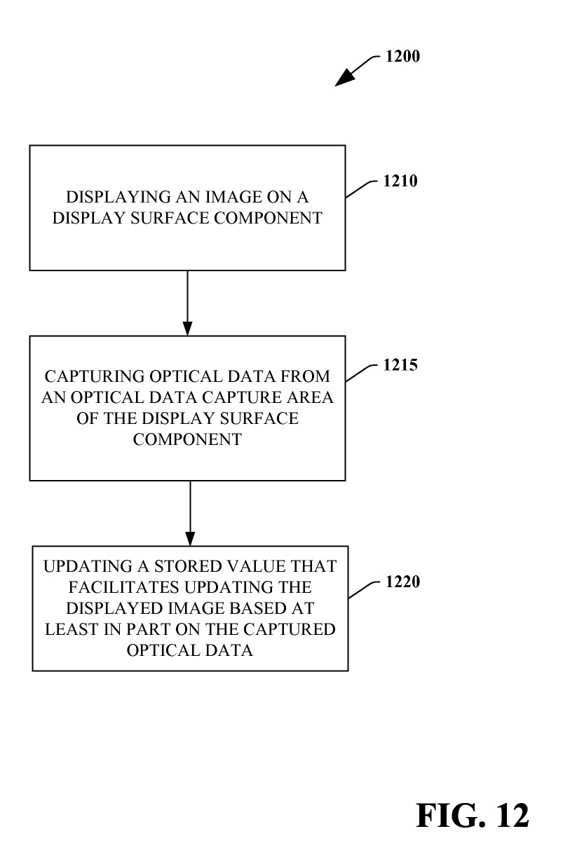

FIGS. 12-15 illustrate methodologies, flow diagrams, and/or timing diagrams in accordance with the disclosed subject matter. It is to be appreciated that the methodologies presented herein can incorporate actions pertaining to a neural network, an expert system, a fuzzy logic system, and/or a data fusion component, or a combination of these, which can generate diagnostics indicative of the optimization of FPS capacity allocation operations germane to the disclosed methodologies. Further, the prognostic analysis of this data can serve to better optimize FPS capacity allocation operations, and can be based on real time acquired data or historical data within a methodology or from components related to a methodology herein disclosed, among others. It is to be appreciated that the subject invention can employ highly sophisticated diagnostic and prognostic data gathering, generation and analysis techniques, and such should not be confused with trivial techniques such as simply powering down a device when a benchmark is reached.

For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states by way of a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIG. 12, illustrated is a methodology 1200 that can facilitate information display with optical data capture in accordance with an aspect of the subject matter disclosed herein. Conventionally, imaging of objects is from the same side of a display surface as the object (e.g. typically the display surface is NOT disposed between the imaging component and the imaged object). This can result in obfuscation of the object (e.g., the user can hide portions or all of the object being optically imaged) and can be limited in that the surface of the object in contact with the display surface may not be imaged.

In contrast, methodology 1200 facilitates imaging of an object through an information display surface. At 1210 an image can be displayed on a display surface component. At 1215 optical data from an object interacting with the display surface component can be captured through the display surface component (e.g., the display surface component is disposed between the object and the component capturing the optical data of the object.) At 1220, a stored value can be updated based at least in part on the captured optical data. This stored value facilitates updating the information displayed on the display surface. For example, the color of an object can be stored such that a determination that the object is a lemon can be made and the display can be updated to show the price of a lemon. At this point methodology 1200 can end.

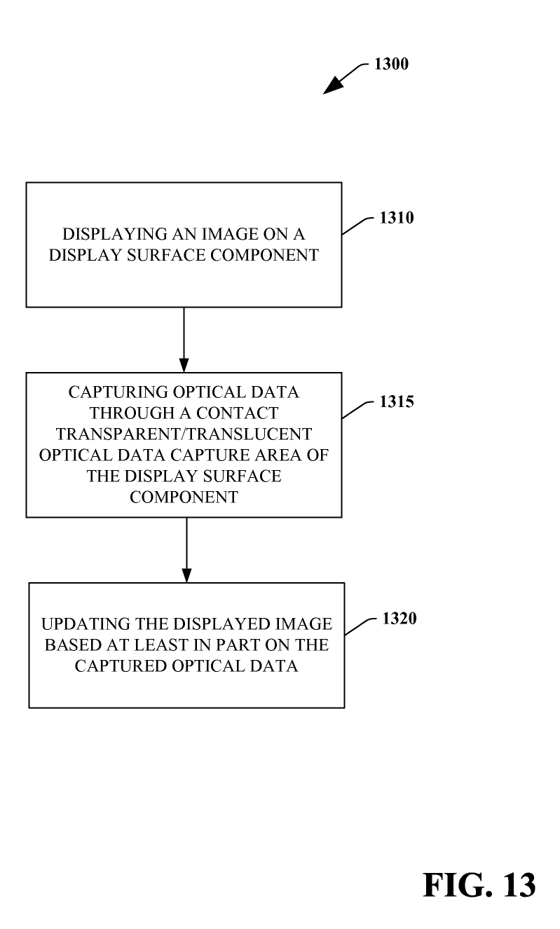

Referring now to FIG. 13, illustrated is a methodology 1300 that can facilitate information display with optical data capture in accordance with an aspect of the subject matter disclosed herein. Methodology 1300 can be the same as or similar to methodology 1200 in that 1310 and 1320 can be the same or similar as 1210 and 1220 respectively. At 1315 optical data can be captured through a contact transparent ODCA as herein disclosed.

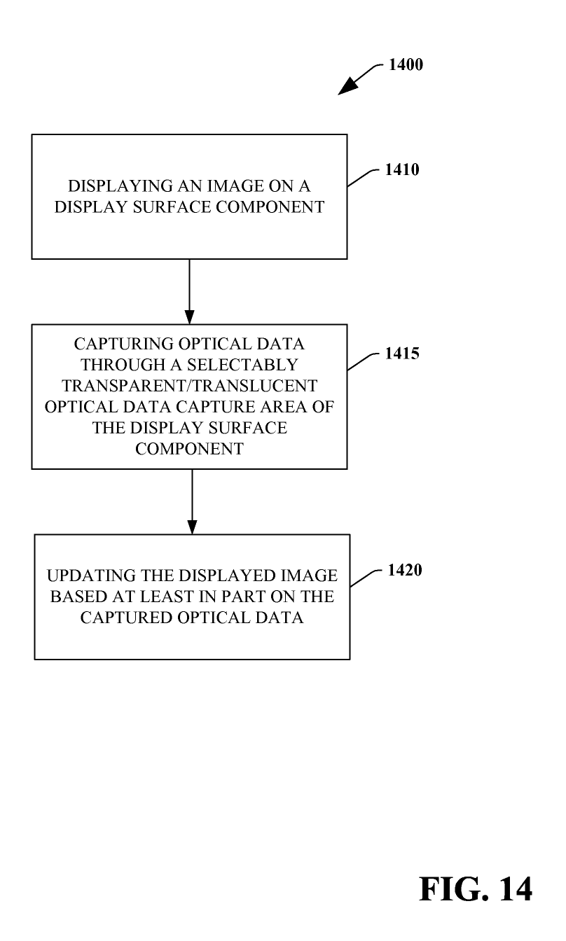

Referring now to FIG. 14, illustrated is a methodology 1400 that can facilitate information display with optical data capture in accordance with an aspect of the subject matter disclosed herein. Methodology 1400 can be the same as or similar to methodology 1200 in that 1410 and 1420 can be the same or similar as 1210 and 1220 respectively. At 1415 optical data can be captured through an optically selectable ODCA as herein disclosed.

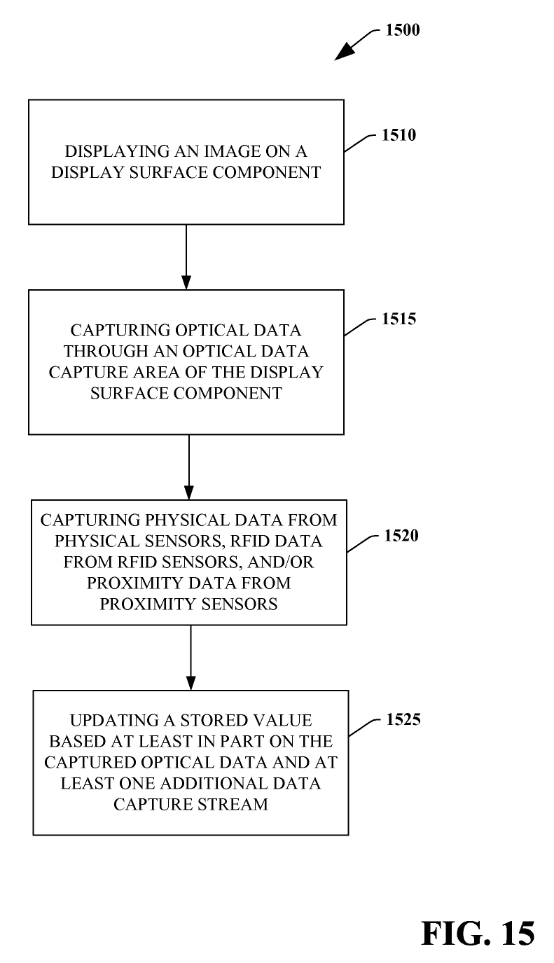

Referring now to FIG. 15, illustrated is a methodology 1500 that can facilitate information display with optical data capture with additional sensor component inputs in accordance with an aspect of the subject matter disclosed herein. At 1510 an image can be displayed on a display surface component. At 1515 optical data can be captured through the display surface component (e.g. the display surface component is disposed between the object and the component capturing the optical data of the object.) At 1520, additional data can be captured form physical sensors, RFID sensors, and/or proximity sensors as herein described. At 1525, a stored value can be updated based at least in part on the captured optical data and at least one additional data capture stream (e.g., data from 1520). At this point methodology 1200 can end.

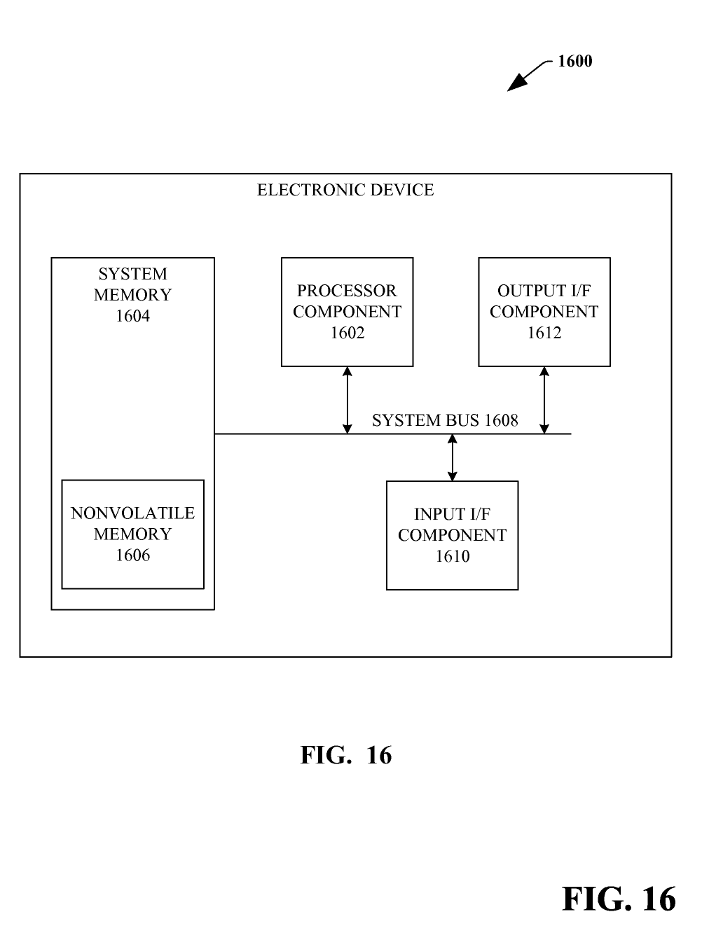

Referring to FIG. 16, illustrated is a block diagram of an exemplary, non-limiting electronic device 1600 that can include an information display with optical data capture in accordance with one aspect of the disclosed subject matter. The electronic device 1100 can include, but is not limited to, a computer, a laptop computer, network equipment (e.g. routers, access points), a media player and/or recorder (e.g., audio player and/or recorder, video player and/or recorder), a television, a smart card, a phone, a cellular phone, a smart phone, an electronic organizer, a PDA, a portable email reader, a digital camera, an electronic game (e.g., video game), an electronic device associated with digital rights management, a Personal Computer Memory Card International Association (PCMCIA) card, a trusted platform module (TPM), a Hardware Security Module (HSM), set-top boxes, a digital video recorder, a gaming console, a navigation system (e.g. global position satellite (GPS) system), secure memory devices with computational capabilities, devices with tamper-resistant chips, an electronic device associated with an industrial control system, an embedded computer in a machine (e.g., an airplane, a copier, a motor vehicle, a microwave oven), and the like.

Components of the electronic device 1600 can include, but are not limited to, a processor component 1602, a system memory 1604 (with nonvolatile memory 1606), and a system bus 1608 that can couple various system components including the system memory 1604 to the processor component 1602. The system bus 1608 can be any of various types of bus structures including a memory bus or memory controller, a peripheral bus, or a local bus using any of a variety of bus architectures.

Electronic device 1600 can typically include a variety of computer readable media. Computer readable media can be any available media that can be accessed by the electronic device 1600. By way of example, and not limitation, computer readable media can comprise computer storage media and communication media. Computer storage media can include volatile, non-volatile, removable, and non-removable media that can be implemented in any method or technology for storage of information, such as computer readable instructions, data structures, program modules or other data. Computer storage media includes, but is not limited to, RAM, ROM, EEPROM, nonvolatile memory 1606 (e.g., flash memory), or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by electronic device 1600. Communication media typically can embody computer readable instructions, data structures, program modules or other data in a modulated data signal such as a carrier wave or other transport mechanism and includes any information delivery media.

The system memory 1604 can include computer storage media in the form of volatile and/or nonvolatile memory 1606. A basic input/output system (BIOS), containing the basic routines that help to transfer information between elements within electronic device 1600, such as during start-up, can be stored in memory 1604. Memory 1604 can typically contain data and/or program modules that can be immediately accessible to and/or presently be operated on by processor component 1602. By way of example, and not limitation, system memory 1604 can also include an operating system, application programs, other program modules, and program data.

The nonvolatile memory 1606 can be removable or non-removable. For example, the nonvolatile memory 1606 can be in the form of a removable memory card or a USB flash drive. In accordance with one aspect, the nonvolatile memory 1606 can include flash memory (e.g. single-bit flash memory, multi-bit flash memory), ROM, PROM, EPROM, EEPROM, or NVRAM (e.g., FeRAM), or a combination thereof, for example. Further, the flash memory can be comprised of NOR flash memory and/or NAND flash memory.

A user can enter commands and information into the electronic device 1600 through input devices (not shown) such as a keypad, microphone, tablet or touch screen although other input devices can also be utilized (e.g. the information display with optical data capture can be employed as an input device such as, for example, a virtual keyboard, etc.). These and other input devices can be connected to the processor component 1602 through input interface component 1612 that can be connected to the system bus 1608. Other interface and bus structures, such as a parallel port, game port or a universal serial bus (USB) can also be utilized. A graphics subsystem (not shown) can also be connected to the system bus 1608. A display device (not shown) can be also connected to the system bus 1608 via an interface, such as output interface component 1612, which can in turn communicate with video memory. In addition to a display, the electronic device 1600 can also include other peripheral output devices such as speakers (not shown), which can be connected through output interface component 1612.

It is to be understood and appreciated that the computer-implemented programs and software can be implemented within a standard computer architecture. While some aspects of the disclosure have been described above in the general context of computer-executable instructions that may run on one or more computers, those skilled in the art will recognize that the technology also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices (e.g., PDA, phone), microprocessor-based or programmable consumer electronics, and the like, each of which can be operatively coupled to one or more associated devices.

The illustrated aspects of the disclosure may also be practiced in distributed computing environments where certain tasks are performed by remote processing devices that are linked through a communications network. In a distributed computing environment, program modules can be located in both local and remote memory storage devices.

As utilized herein, terms “component,” “system,” “interface,” and the like, can refer to a computer-related entity, either hardware, software (e.g. in execution), and/or firmware. For example, a component can be, but is not limited to being, a process running on a processor, a processor, a circuit, a collection of circuits, an object, an executable, a thread of execution, a program, and/or a computer. By way of illustration, both an application running on a server and the server can be a component. One or more components can reside within a process and a component can be localized on one computer and/or distributed between two or more computers.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the disclosed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

### Artificial Intelligence

Artificial intelligence based systems (e.g. explicitly and/or implicitly trained classifiers) can be employed in connection with performing inference and/or probabilistic determinations and/or statistical-based determinations as in accordance with one or more aspects of the disclosed subject matter as described herein. As used herein, the term “inference,” “infer” or variations in form thereof refers generally to the process of reasoning about or inferring states of the system, environment, and/or user from a set of observations as captured through events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the disclosed subject matter.

For example, an artificial intelligence based system can evaluate current or historical evidence associated with historical optical data capture (e.g., prior device usage by one or more users, training, or machine learning (e.g., amount of data, type of data, redundancy of data, prior data accuracy, among many others), user interactions, or combinations thereof, among others, . . . ) and based in part in such evaluation, can render an inference, based in part on probability, regarding, for instance, the probability of an apple being a Fuji type apple or a Braeburn type apple based on prior optical data capture and historical accuracy, among other such examples of probabilistic determinations. One of skill in the art will appreciate that intelligent and/or inferential systems can facilitate further optimization of the disclosed subject matter and such inferences can be based on a large plurality of data and variables all of with are considered within the scope of the subject innovation.

What has been described above includes examples of aspects of the disclosed subject matter. It is, of course, not possible to describe every conceivable combination of components or methodologies for purposes of describing the disclosed subject matter, but one of ordinary skill in the art will recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has,” or “having,” or variations thereof, are used in either the detailed description or the claims, such terms are intended to be inclusive in a manner similar to the term “comprising” as “comprising” is interpreted when employed as a transitional word in a claim.

What is claimed is:

1. A system that facilitates an information display with optical data capture comprising:
a display surface whereon information is displayed;
an optical data capture component that captures optical data through regions of the display surface that can also display information; and
a display controller component that updates the displayed information based at least in part on captured optical data.

2. The system of claim 1 wherein the display surface further comprises at least one contact transparent material.

3. The system of claim 2, wherein the contact transparent material comprises one or more portions of the display surface.

4. The system of claim 1 wherein the display surface further comprises at least one optically selectable material.

5. The system of claim 4, wherein the optically selectable material comprises one or more portions of the display surface.

6. The system of claim 1, wherein the display surface further comprises at least one contact transparent material and at least one optically selectable material.

7. The system of claim 6, wherein the at least one contact transparent material and at least one optically selectable material are spatially distinct, nested, or some combination thereof

8. The system of claim 1, further comprising an RFID component that can access an RFID tag, a proximity sensor component that can determine the proximity of an object with respect to the display surface, a physical sensor that can sense a physical, electrical, or chemical attribute of an object interacting with the display surface, or some combination thereof.

9. The system of claim 1, wherein the displayed information is selectably rotatable by a predetermined amount.

10. The system of claim 1, wherein the displayed information is dynamically modified to present predetermined user interfaces based at least in part upon the type of optical data to be captured, a number of users, a context of a user, or some combination thereof.

11. The system of claim 1, embodied in a point of sale system, an information kiosk system, a security system, a banking system, a health and wellness system, a customer service system, or some combination thereof.

12. The system of claim 1, further comprising at least one contact transparent material to facilitate optical masking of objects interacting with the display surface.

13. The system of claim 1, further comprising at least one material having contact transparency properties based at least in part on internal dyes, diffraction gratings, refraction gratings, lensing, deformable surfaces, material surface patterning or distress, inks, laminar structures, molecular or crystalline structures or arrangements, or some combination thereof.

14. The system of claim 1, further comprising at least one optically selectable material wherein that material is smart glass or switchable glass.

15. The system of claim 1, wherein the optical data captured is in at least the visible spectrum, UV spectrum, IR spectrum, a predetermined narrow spectral band, a predetermined broad spectral band, or some combination thereof.

16. The system of claim 1, wherein the optical data captured comprises optical data from a plurality of perspectives relative to an imaged object, optical data over time, optical data at one or more levels of zoom, optical data from a plane not co-planar with the display surface, or some combination thereof.

17. An electronic device comprising:
a display surface whereon information is displayed;
an optical data capture component that captures optical data, related to objects interacting with the display surface, through regions of the display surface that can also display information; and
a display controller component that updates the displayed information based at least in part on captured optical data.

18. A method that facilitates information display with optical data capture comprising:
displaying an image on a display surface;
capturing optical data related to an object interacting with the display surface through a region of the display surface that is capable of displaying information;
updating a stored value that facilitates updating the displayed image, based at least in part upon the captured optical data.

19. The method of claim 18, further comprising accessing data related to an RFID component that can access an RFID tag, a proximity sensor component that can determine the proximity of an object with respect to the display surface, a physical sensor that can sense a physical, electrical, or chemical attribute of an object interacting with the display surface, or some combination thereof.

20. The method of claim 18, wherein capturing optical data occurs through a portion of the display surface comprising a contact transparent material, an optically selectable material, smart glass, switchable glass, or some combination thereof.
